(19) United States
(12) Patent Application Publication
(10) Pub. No.: US 2026/0153484 A1
(43) Pub. Date: Jun. 4, 2026

(54) DEFECT DETECTION MODULE, DEFECT DETECTION APPARATUS, AND DEFECT DETECTION METHOD

(71) Applicant: Samsung Electronics Co., Ltd., Suwon-si (KR)

(72) Inventors: Seokkyu LEE, Suwon-si (KR); Kwankyu PARK, Seoul-si (KR); Minho KIM, Suwon-si (KR); Giho JEONG, Suwon-si (KR); Sejong GHANG, Suwon-si (KR); Hyunsu KIM, Seoul-si (KR); Hyeonggeun JO, Seoul-si (KR)

(73) Assignees: Samsung Electronics Co., Ltd., Suwon-si (KR); IUCF-HYU (Industry-University Cooperation Foundation Hanyang University), Seoul (KR)

(21) Appl. No.: 19/220,572

(22) Filed: May 28, 2025

(30) Foreign Application Priority Data
Dec. 4, 2024 (KR) 10-2024-0178889

(51) Int. Cl. G01N 29/44; G01N 29/06; G01N 29/48

(52) U.S. Cl. CPC G01N 29/4472; G01N 29/069; G01N 29/48; G01N 2291/023; G01N 2291/0289; G01N 2291/101

(57) ABSTRACT

A defect detection module may include a data collector configured to collect reflected signal data of an amplitude-mode ultrasonic wave for a test subject, a data preprocessor configured to generate merged reflected signal data by extracting a portion of the reflected signal data, assigning numbers to the extracted portion of the reflected signal data, normalizing amplitudes of the extracted portion of the reflected signal data, and then merging the extracted portion of the reflected signal data, a training data generator configured to generate a training dataset by detecting a position of a defect within the test subject by performing principal component analysis on the merged reflected signal data, and classifying the merged reflected signal data into defect-including data and defect-free data, and a defect detector configured to detect a defect in the test subject through the training dataset by using a deep learning model.

### CROSS-REFERENCE TO RELATED APPLICATION

This application is based on and claims priority under 35 U.S.C. § 119 to Korean Patent Application No. 10-2024-0178889, filed on Dec. 4, 2024, in the Korean Intellectual Property Office, the disclosure of which is incorporated by reference herein in its entirety.

### BACKGROUND

The inventive concepts relate to a defect detection module, a defect detection apparatus, and a defect detection method, and more particularly, to a defect detection module, a defect detection apparatus, and a defect detection method, wherein defects may be detected in a stacked semiconductor.

In response to the demand for size reduction and higher performance in semiconductor packages, a stacked semiconductor package, in which a plurality of semiconductor chips are vertically stacked to form a single package, has been widely adopted. In a stacking process, defects such as debonding, delamination, and cracks may occur between semiconductor chips. These defects may progressively enlarge due to repeated heat stress or mechanical shock, and the enlarged defects may compromise the reliability of a package. Non-destructive testing using ultrasound is widely used to detect internal defects. Recently, technologies have been developed to detect defects by applying artificial intelligence techniques, such as deep learning and machine learning, to ultrasonic testing.

### SUMMARY

At least one example embodiment of the inventive concepts may provide a defect detection module, a defect detection apparatus, and a defect detection method, wherein the position and type of defect present inside a three-dimensional stacked semiconductor may be automatically detected.

In addition, the inventive concepts are not limited to the above objectives, and other objectives may be clearly understood by those of ordinary skill in the art from descriptions below.

According to an aspect of the inventive concepts, provided is a defect detection module including processing circuitry configured to collect reflected signal data of an amplitude-mode ultrasonic wave for a test subject; generate merged reflected signal data by extracting a portion of the collected reflected signal data, assigning numbers to the extracted portion of the collected reflected signal data, normalizing amplitudes of the extracted portion of the collected reflected signal data, and then merging the extracted portion of the collected reflected signal data; generate a training dataset by detecting a position of a defect within the test subject using a principal component analysis on the merged reflected signal data, and classifying the merged reflected signal data into defect-including data and defect-free data; and detect the defect in the test subject using the training dataset and a deep learning model, wherein the collected reflected signal data is collected as a position of the amplitude-mode ultrasonic wave is changed relative to the test subject.

According to another aspect of the inventive concepts, provided is a defect detection apparatus including a stage configured to receive a test subject, an ultrasonic transceiver configured to generate reflected signal data by transmitting an ultrasonic wave toward the test subject, and receiving the ultrasonic wave reflected from the test subject, a controller configured to control the stage and the ultrasonic transceiver, and a defect detection module configured to preprocess the reflected signal data, and to detect a defect in the test subject using a deep learning model and the preprocessed reflected signal data, wherein the ultrasonic wave is an amplitude-mode ultrasonic wave, and the reflected signal data is formed by changing a distance between the ultrasonic transceiver and the test subject.

According to another aspect of the inventive concepts, provided is a defect detection method including collecting reflected signal data from an amplitude-mode ultrasonic wave applied to a test subject; extracting a portion of the collected reflected signal data; assigning numbers to the extracted portion of the collected reflected signal data; normalizing amplitudes of the extracted portion of the collected reflected signal data; merging the normalized portion of the collected reflected signal data; generating a training dataset by detecting a position of a defect within the test subject by performing principal component analysis on the merged reflected signal data and classifying the merged reflected signal data into defect-including data and defect-free data; detecting the defect in the test subject using the training dataset and a deep learning model based on the training dataset; comparing the defect detected in the defect detection step with the defect detected in the training data generating step; and generating and outputting a defect image including the defect when the defect detected in the defect detection step matches the defect detected in the training data generating step.

### BRIEF DESCRIPTION OF THE DRAWINGS

Embodiments of the inventive concepts will be more clearly understood from the following detailed description taken in conjunction with the accompanying drawings in which:

FIG. 1 is a schematic block diagram of a defect detection module according to at least one example embodiment;

FIG. 2 is a schematic block diagram showing an example of a data preprocessor of FIG. 1;

FIGS. 3A to 3E are diagrams illustrating states where the distance between an ultrasonic transceiver and a test subject varies;

FIG. 4 is a graph illustrating reflected signal data measured in states where the distance between an ultrasonic transceiver and a test subject varies;

FIG. 5 is a graph illustrating merged signal data;

FIG. 6 is a schematic block diagram illustrating an example of a training data generator of FIG. 1;

FIG. 7 is a diagram of a merged signal dataset;

FIG. 8 is a graph illustrating results of principal component analysis of merged reflected signal data;

FIG. 9 is a diagram visualizing results of principal component analysis of merged reflected signal data;

FIG. 10 is a schematic block diagram of a deep learning model;

FIG. 11 is a schematic block diagram of a defect detection module according to at least one embodiment;

FIG. 12 is a schematic block diagram illustrating an example of a defect re-detector of FIG. 11;

FIG. 13 is a schematic block diagram of a defect detection apparatus according to at least one example embodiment; and

FIG. 14 is a schematic flowchart illustrating a defect detection method according to at least one example embodiment.

### DETAILED DESCRIPTION OF THE EMBODIMENTS

Hereinafter, embodiments are described in detail with reference to the accompanying drawings. However, the inventive concepts are not limited to the embodiments described below and may be embodied in various other forms. The embodiments described below are provided not to fully complete the inventive concepts, but to sufficiently convey the scope of the inventive concepts to those of ordinary skill in the art.

Functional units configured to process at least one function or operation, including those described using terms such as “unit”, “processor”, “module” and/or the like, may be implemented in and/or by processing circuitry, such as hardware, software, or a combination of hardware and software. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc. Unless expressly indicated otherwise, elements within a functional unit may communicate with each other, through a bus such as, but not limited to, a wireless bus and/or a wired bus, to exchange information, stored in various formats such as, but not limited to, an analog format and/or a digital format, and may communicate to transmit and/or receive the information in various manners, such as but not limited to a one-way manner, a two-way manner, or a multiway manner; the information may be sent and/or received in various manners such as, but not limited to, a serial manner and/or a parallel manner. However, the example embodiments are not limited thereto.

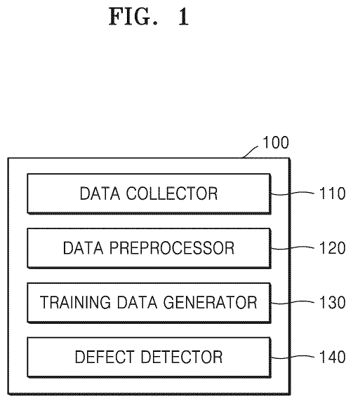

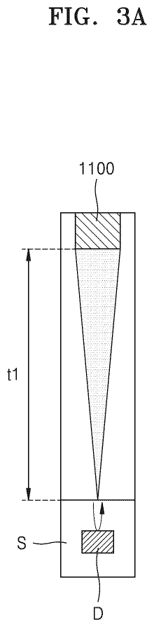

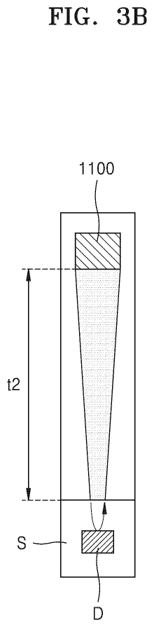

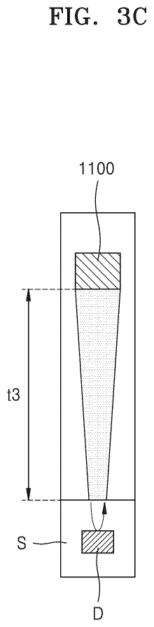

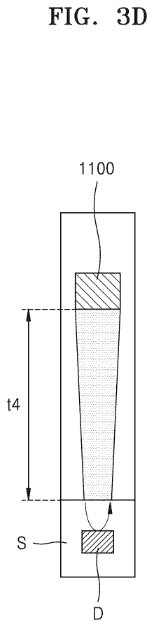

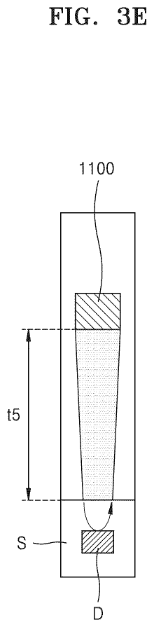

Referring to FIG. 1, a defect detection module 100 according to at least one example embodiment includes a data collector 110, a data preprocessor 120, a training data generator 130, and a defect detector 140. The defect detection module 100 is configured to detect an internal defect in a test subject S (see FIG. 3A).

In at least some examples, the test subject S is a stacked semiconductor package in which a plurality of semiconductor chips are vertically stacked. The stacked semiconductor package may have a structure in which semiconductor chips are bonded together by using an adhesive. The stacked semiconductor package may experience defects, such as debonding, delamination, and cracks, during a manufacturing process. These defects may occur primarily at interfaces between semiconductor chips, and the size of the defects may range from several micrometers to hundreds of micrometers.

The data collector 110 may collect an ultrasonic signal from an ultrasonic test of the test subject S. For example, the data collector 110 may receive, from an ultrasonic transceiver, a reflected signal of amplitude-mode (A-mode) ultrasonic waves. Thereby, in at least some examples, the data collector 110 may include (or be attached to) an ultrasonic receiver and/or transceiver. The ultrasonic test may include irradiating A-mode ultrasonic waves towards the test subject S and sequentially changing the position thereof in a vertical direction of the test subject S, such that the data collector 110 may collect, as time series data, an ultrasonic signal reflected at each position. The reflected signal may be a signal generated when ultrasonic waves are reflected at a boundary of different media and/or from a defect within the test subject S. In some example embodiments, the data collector 110 may generate reflected signal data including amplitude, phase, and time information about the collected signal. Also, the data collector 110 may add, to the reflected signal data, position information or test condition information about the test subject S. The data collector 110 may transmit the generated reflected signal data to the data preprocessor 120.

The data preprocessor 120 is configured to preprocess the reflected signal data and convert the reflected signal data into a form suitable for (e.g., compatible with) training and analysis. For example, the data preprocessor 120 may be configured to extract significant signals (e.g., signals of statistical significance and/or signals of which an absolute value of the amplitude exceeds a certain threshold value) from the reflected signal data, normalize the extracted signals into a certain format, and merge the normalized signals to form one dataset.

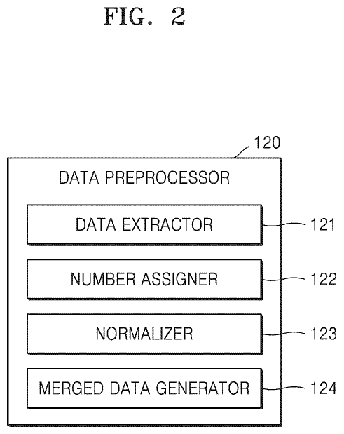

FIG. 2 is a block diagram illustrating a detailed configuration of the data preprocessor 120 according to at least one example embodiment.

Referring to FIG. 2, an example of the data preprocessor 120 includes a data extractor 121, a number assigner 122, a normalizer 123, and a merged data generator 124.

The data extractor 121 may be configured to selectively extract, from the reflected signal data, signals significant for defect detection. For example, the data extractor 121 may extract, from the reflected signal data, signals of which an absolute value of the amplitude exceeds a certain threshold value. The threshold value is a reference value for distinguishing between normal reflected signals and noise, and may be adaptively set according to the characteristics of a test subject S or test conditions. The data extractor 121 may detect peak signals exceeding the threshold value and generate extraction data including time information and amplitude information about the detected peak signals. In some embodiments, the data extractor 121 may extract signals within a certain range around the peak signals together to preserve shape information about the signals.

The number assigner 122 may be configured to sort pieces of the extracted reflected signal data in time order and assign a serial number to each of the pieces of the extracted reflected signal data. The serial number indicates the order of generation of a reflected signal and may be used to identify the position of a defect within the test subject S. The number assigner 122 may perform sorting based on time information about the pieces of the extracted reflected signal data and assign, as serial numbers, consecutive natural numbers starting from 1 in the sorted order. Also, the number assigner 122 may map the serial number to position information about the test subject S regarding a position where a corresponding reflected signal was detected, and store the same.

The normalizer 123 may be configured to normalize the amplitude of the pieces of the extracted reflected signal data and convert the normalized pieces of reflected signal data into a form in which different signals may be directly compared. For example, normalization of a signal may be a process of preserving the relative magnitudes of reflected signals measured at different positions and adjusting the difference in absolute amplitude values to a standardized range. For example, the normalizer 123 may apply minimum-maximum (min-max) normalization and/or a Z-score normalization to each of the pieces of the extracted reflected signal data. For min-max normalization, the amplitude of a reflected signal may be transformed to a value between 0 and 1, and for Z-score normalization, the amplitude of the reflected signal may be transformed to a distribution with a mean of 0 and a standard deviation of 1. The normalizer 123 stores transformation parameters according to a normalization method, and the transformation parameters may be utilized for normalizing new reflected signal data in the future.

The merged data generator 124 may be configured to merge the normalized pieces of reflected signal data into one dataset, e.g., in the order of the serial numbers assigned by the number assigner 122. For example, the merged data generator 124 may generate merged data in the form of a time series by arranging the pieces of normalized reflected signal data in time order. The merged data may include one or more of a serial number, a normalized amplitude value, time information, and position information for each of the pieces of the reflected signal data.

The merged data generator 124 may be configured to perform outlier detection and filtering to improve the consistency and quality of a signal during a merging process. The outlier detection may be performed by combining a statistical method with a machine learning-based method. For example, the merged data generator 124 may calculate a standard deviation from the mean of an amplitude value of each reflected signal and identify values that deviate from a set threshold value (e.g., ±3σ) as outliers. Also, the merged data generator 124 may detect outliers that deviate from a normal signal pattern by using a machine learning algorithm, such as Isolation Forest or Local Outlier Factor.

For data identified as outliers, a filtering process that considers the continuity of a signal may be used. The merged data generator 124 may alleviate rapid signal changes by using at least one of a moving average filter or a median filter. For example, when a signal value at a certain time point deviates significantly (e.g., beyond a threshold value and/or a threshold percentage) from preceding and following signals, the continuity of the signal may be maintained by replacing the signal value with a moving average within a corresponding range. Also, the quality of a signal may be improved by applying a noise removal technique using wavelet transform.

In some embodiments, the merged data generator 124 may constantly correct a time interval between the pieces of reflected signal data during a merging process. Time interval correction may be performed by using linear interpolation or spline interpolation. This may minimize signal distortion caused by irregular sampling intervals.

Also, the merged data generator 124 may perform zero padding to maintain a constant length of merged data. In zero padding, a gradually decreasing weight may be applied to account for discontinuities that may occur at the beginning and end of the signal. This merged data may be transmitted to the training data generator 130 and used to generate a training dataset for defect detection.

The merged data generator 124 may calculate statistical indicators to verify the quality of processed data. For example, the quality of merged data may be quantitatively evaluated by monitoring indicators, such as a signal-to-noise ratio, kurtosis, and skewness. These quality indicators may be utilized as data selection criteria during a subsequent training dataset generation process.

FIGS. 3A to 3E are diagrams illustrating states where the distance between an ultrasonic transceiver 1100 and a test subject S varies.

Referring to FIGS. 3A to 3E, an ultrasound test may be performed while gradually changing the distance between the ultrasonic transceiver 1100 and the test subject S. In FIG. 3A, the distance between the ultrasonic transceiver 1100 and the test subject S may be set to a greatest distance t1. In FIG. 3B, the distance between the ultrasonic transceiver 1100 and the test subject S may be set to a distance t2, which may have a smaller value than the distance t1. In FIG. 3C, the distance between the ultrasonic transceiver 1100 and the test subject S may be set to a distance t3, which may have a smaller value than the distance t2. In FIG. 3D, the distance between the ultrasonic transceiver 1100 and the test subject S may be set to a distance t4, which may have a smaller value than the distance t3. In FIG. 3E, the distance between the ultrasonic transceiver 1100 and the test subject S may be set to a smallest distance t5.

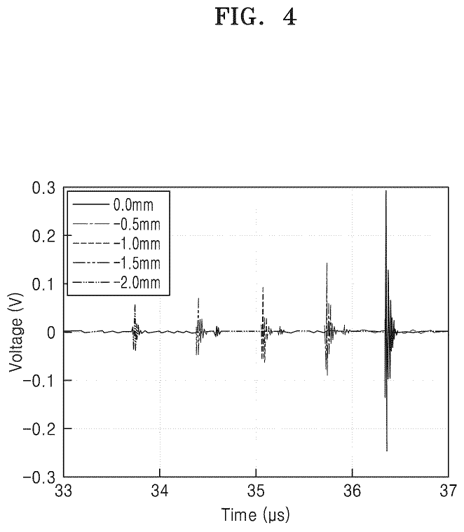

FIG. 4 is a graph illustrating reflected signal data measured in states where the distance between the ultrasonic transceiver 1100 and the test subject S varies.

Referring to FIG. 4, a graph in which the x-axis represents time and the y-axis represents amplitude in voltage units is shown. The graph shows reflected signal data measured at different distances as described in FIGS. 3A to 3E. As the distance between the ultrasonic transceiver 1100 and the test subject S increases, the round-trip time of ultrasonic waves increases, resulting in a delay in the time at which the peak of a reflected signal occurs. That is, the peak of the reflected signal measured at the distance t1 appears last, and as the distance decreases, the peak of the reflected signal appears progressively earlier. The peak of the reflected signal measured at the distance t5 appears first. An amplitude value of the reflected signal may be different for each signal and may be affected by various physical phenomena of ultrasonic waves, such as attenuation, scattering, and reflection.

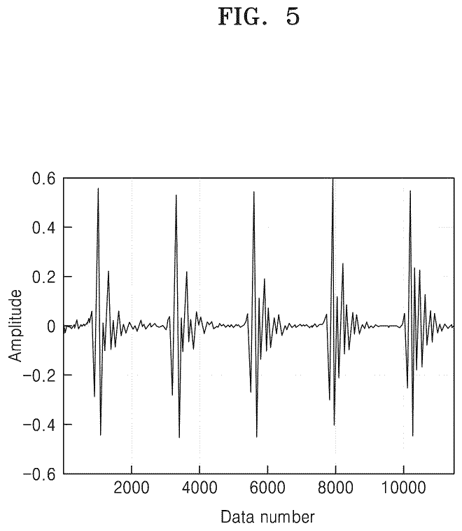

FIG. 5 is a graph illustrating merged signal data.

Referring to FIG. 5, a graph in which the x-axis represents a serial number assigned to each piece of reflected signal data and the y-axis represents a normalized amplitude value is shown. This graph shows results of merging the pieces of reflected signal data measured at different distances, as shown in FIG. 4, into one dataset. Each piece of reflected signal data is assigned a serial number in time order, and the amplitude value is normalized to a range between 0 and 1. This merged data facilitates comparison and analysis of relative characteristics of each reflected signal and may be utilized as training data for defect detection. A variation pattern of the normalized amplitude value may include information about the condition of the test subject S or the presence of a defect.

The training data generator 130 may analyze the merged reflected signal data received from the data preprocessor 120 to detect a defect in a test subject S and to generate a training dataset based on the analysis. The training data generator 130 may perform principal component analysis (PCA) on the merged reflected signal data to extract major features of the merged reflected signal data, thereby identifying the presence and position of a defect. Based on results of the identification, the merged reflected signal data may be classified into defective data and non-defective data, thereby generating a dataset in a form suitable for training a deep learning model for defect detection. In at least some embodiments, the deep learning model may be (or include) at least one of a multi-layer perceptron (MLP), a convolutional neural network (CNN), or a recurrent neural network (RNN).

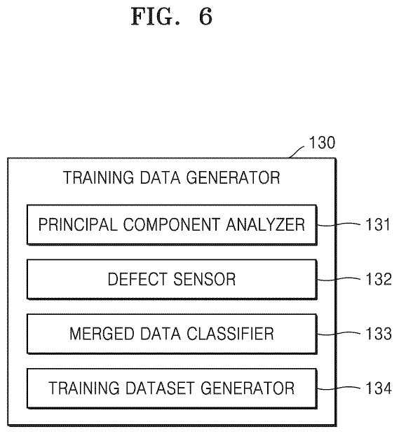

FIG. 6 is a schematic block diagram illustrating an example of the training data generator 130 of FIG. 1.

Referring to FIG. 6, an example of the training data generator 130 includes a principal component analyzer 131, a defect sensor 132, a merged data classifier 133, and a training dataset generator 134.

The principal component analyzer 131 may be configured to perform PCA to extract key features from the merged reflected signal data and to reduce the dimension of the merged reflected signal data in order to increase the efficiency of the training. The principal component analyzer 131 may find a new basis orthogonal to a direction that maximizes the variance of high-dimensional data and project the high-dimensional data into a low-dimensional space.

The principal component analyzer 131 may first perform mean centering on the input merged reflected signal data. Mean centering is a process of determining the mean (or average) of each feature and subtracting the mean from each data point, which moves the center of data towards the origin. When a mean-centered data matrix is X, a covariance matrix C may be calculated as follows:

$$C = ( 1 / n ) {X}^{T} X \qquad Equation ( 1 )$$

In this case, n denotes the number of data points, and X\hat{ }T denotes a transpose matrix of X.

The principal component analyzer 131 may perform eigenvalue decomposition on the calculated covariance matrix. An eigenvalue and an eigenvector of the covariance matrix may be obtained through eigenvalue decomposition. The eigenvector represents a principal direction of variation in data, and a corresponding eigenvalue represents the magnitude of variance in the direction. The principal component analyzer 131 may determine a principal component by sorting eigenvectors in order of increasing eigenvalues.

The principal component analyzer 131 may determine the number of principal components necessary to explain a desired proportion (e.g., 95 %) of the total variance. The proportion of variance explained by each principal component may be calculated by dividing a corresponding eigenvalue by the sum of all eigenvalues. A projection matrix W may be constructed by using the determined number of principal components, and original data may be projected into a low-dimensional space as shown in the following Equation (2):

$$Y = XW \qquad Equation ( 2 )$$

In this case, Y denotes dimensionally reduced data.

The principal component analyzer 131 may calculate a reconstruction error that occurs during a data projection process. The reconstruction error represents the difference between the original data and the data that has been projected into the low-dimensional space and then restored back to the original dimension. This error may be calculated by using the following Equations (3) and (4):

$${X}^{′} = {YW}^{T} \qquad Equation ( 3 )$$

$$E = ‖ X - {X}^{′} ‖ \qquad Equation ( 4 )$$

In this case, X′ denotes reconstructed data, and E denotes a reconstruction error.

The principal component analyzer 131 may be sensitive to data scaling, and thus, data normalization may be performed when applicable. As normalization methods, standardization, which involves subtracting the mean from each feature and dividing the same by the standard deviation, or min-max normalization, which involves adjusting the range of features to the interval [0, 1], may be used.

Also, the principal component analyzer 131 may perform cross-validation of the principal component analysis to evaluate the stability of analysis results. Accordingly, it may be verified whether the number of selected principal components is appropriate and whether extracted features effectively reflect general characteristics of data.

The defect sensor 132 may be configured to detect a defect within the test subject S by comparing the variance calculated by the principal component analyzer 131 with mask data representing a pattern of the test subject S. In this case, mask data is data regarding a mask to form the pattern of the test subject S and includes information about a normal pattern structure of the test subject S. The variance represents a major change in the merged reflected signal data, and it may be determined that areas with higher variance are more likely to have defects.

The defect sensor 132 may unify the data format to effectively compare PCA results with the mask data. As a first method, variance data obtained from PCA may be converted into the format of mask data. In this process, variance values may be reconstructed by mapping the variance values to position information about the test subject S in a two-dimensional or three-dimensional space, structured identically to the mask data. As a second method, the mask data may be converted into the format of PCA results. In this case, pattern information of the mask data may be projected into a principal component space and converted into a form that may be directly compared with the variance data.

The defect sensor 132 may detect a defect by comparing a normalized variance value with the pattern information of the mask data. An area where the difference from normal patterns represented by the mask data exceeds a certain threshold value may be identified as a defect candidate area. The threshold value may be determined statistically by considering pattern characteristics of the mask data and a variance distribution of a normal area.

The defect sensor 132 may perform additional verification on the identified defect candidate area. Based on the pattern information of the mask data, it may be analyzed how significantly the position, size, and shape of the defect candidate area deviate from a normal structure of the test subject S. Through this verification process, actual defects and natural variations in the pattern may be distinguished.

Also, the defect sensor 132 may classify a detected defect by considering the pattern characteristics of the mask data. The type of defect may be classified based on characteristics of a mask pattern, such as directionality, periodicity, and symmetry, and this may provide useful information for analyzing the cause of defect occurrence. The classification may be unsupervised.

The defect sensor 132 may generate (e.g., calculate) indicators for evaluating the reliability of detection results. These indicators may be calculated by comprehensively considering the strength of a variance value, the deviation from the mask pattern, and structural characteristics of a defective area. Detection results with high reliability may be assigned a greater weight by the merged data classifier 133.

Based on the detection results from the defect sensor 132, the merged data classifier 133 may classify the merged reflected signal data into defect-including data and defect-free data. The merged data classifier 133 may provide information necessary to generate a dataset for training a deep learning model by labeling the classified data with defect characteristics and position information.

The merged data classifier 133 may determine whether there is a defect in each piece of data received from the defect sensor 132. In this process, by using a reliability indicator calculated by the defect sensor 132, the data may be classified as defect-including data, only when the reliability exceeds a certain threshold value. A reliability threshold value may be optimized through experimental verification, and different threshold values may be used according to the type or size of a defect, when necessary.

For data classified as including a defect, detailed characteristic information about the defect may be assigned as a label. Label information may include defect type classification results along with geometric characteristics of the defect, such as position coordinates, size, and shape. This detailed labeling may be utilized as supervised information for the deep learning model to learn and predict various defect characteristics.

The merged data classifier 133 may evaluate and filter the quality of data during a classification process. For example, data with a low signal-to-noise ratio or severe distortion during a measurement process may be excluded from classification. This quality management may contribute to improving the reliability of a training dataset.

Also, the merged data classifier 133 may monitor the distribution of classified data and maintain balance. Because severe imbalance between defective data and non-defective data may degrade the performance of the deep learning model, data sampling strategies may be adjusted to maintain an appropriate ratio when necessary.

The merged data classifier 133 may perform cross-validation to verify the accuracy of the classification results. This may be performed through comparison with a manually verified reference dataset, and performance indicators such as classification accuracy, recall, and precision may be calculated. Verification results may be utilized to optimize classification parameters.

Classified data may be stored with metadata, enabling the tracking of criteria and parameters used in the classification process. This information may ensure the reproducibility of classification results and be referenced to adjust classification criteria when necessary. Finally, the classified data may be transmitted to the training dataset generator 134 and utilized to construct a training dataset for the deep learning model.

The training dataset generator 134 be configured to may generate a dataset optimized for training the deep learning model based on the classified data received from the merged data classifier 133. The training dataset generator 134 may, for example, divide the entire data into training, verification, and test datasets and apply a data augmentation technique to maximize the training effectiveness of the deep learning model.

The training dataset generator 134 may first divide the entire data into training, verification, and test datasets. In general, 60% to 70% of the entire data may be assigned as a training dataset, 15% to 20% thereof may be assigned as a verification dataset, and the other 15% to 20% thereof may be assigned as a test dataset. In this division process, a stratified sampling method may be applied such that each dataset may effectively represent the characteristics of the entire data. In particular, sampling may be performed such that the type and characteristics of a defect are evenly distributed across each dataset. Thereby, in at least some examples, the training dataset may be an unsupervised training dataset for an unsupervised training of the defect detector 140.

Various preprocessing techniques may be used to improve the quality of the training dataset. For example, data consistency and reliability may be ensured through processing, such as outlier removal, noise filtering, and signal normalization. Also, under-sampling or over-sampling techniques may be used to resolve the imbalance between defective data and non-defective data.

Diversity of the training data may be ensured through data augmentation techniques. Transformations such as time-axis shifting, amplitude scaling, noise addition, and phase variation may be applied to signal data. This data augmentation may help the deep learning model learn diverse signal patterns and improve generalization performance. However, parameters need to be set carefully such that the characteristics of the defect are not distorted during a data augmentation process.

The training dataset generator 134 may include appropriate label information for each data sample. The label information may include detailed characteristic information such as the presence of a defect, as well as the position, size and type of the defect. This multi-labeling allows the deep learning model to simultaneously learn different characteristics of the defect.

Statistical analysis may be performed on the generated dataset to verify its quality. The class distribution, characteristic distribution, diversity of defect patterns in each dataset may be analyzed to identify whether the dataset aligns with the training objectives. When necessary, the composition of the dataset may be adjusted based on these analysis results.

The training dataset generator 134 may generate detailed metadata along with the dataset. The metadata may include information about the composition of the dataset, preprocessing methods, augmentation techniques, and labeling data. This metadata may ensure the reproducibility of a model training process and be referenced to update or extend the dataset in the future.

Finally, the generated training dataset may be stored in a format for efficient model training. For example, data may be structured in a format suitable for batch processing, or an indexing structure for memory-efficient data loading may be constructed. Accordingly, the time and resources required for data processing during a training process of the deep learning model may be optimized.

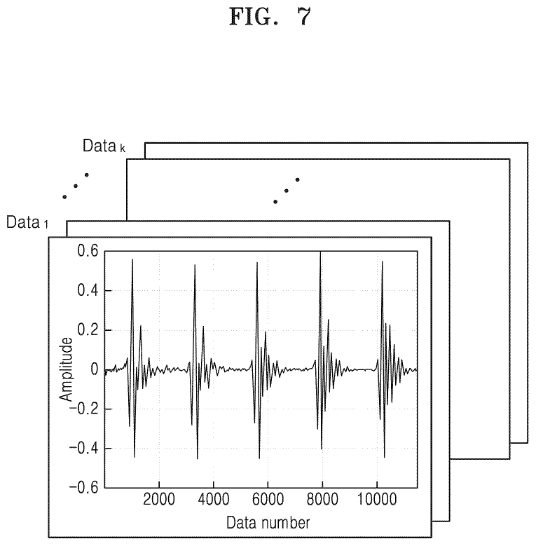

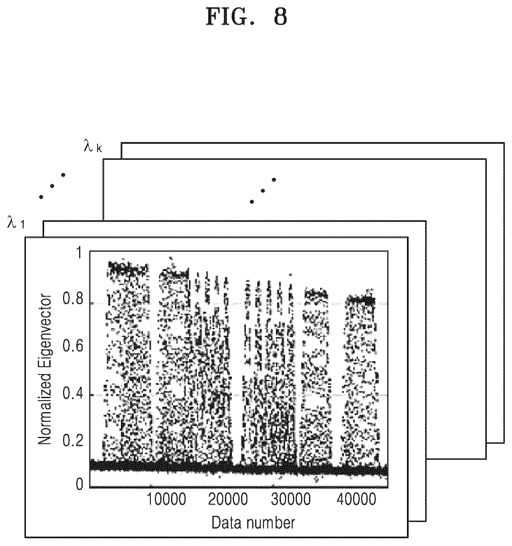

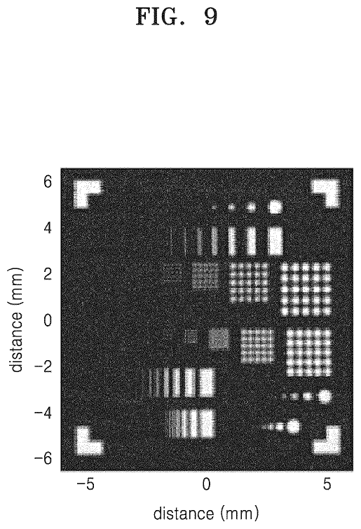

FIG. 7 is a diagram of a merged signal dataset, FIG. 8 is a graph illustrating results of PCA of merged reflected signal data, and FIG. 9 is a diagram visualizing the results of PCA of the merged reflected signal data.

The correlation and processing process of each piece of data are explained with reference to FIGS. 7, 8, and 9.

Referring to FIG. 7, the merged signal dataset may include a plurality of pieces of merged reflected signal data generated by the data preprocessor 120. As described above with reference to FIG. 5, herein a single piece of merged reflected signal data is data in which normalized signals are merged in numerical order. The merged signal dataset may include a set of such pieces of merged reflected signal data obtained at a plurality of positions of a test subject S.

Referring to FIG. 8, PCA results for the merged signal dataset are shown as a two-dimensional graph. A horizontal axis (x-axis) of the graph represents serial numbers of eigenvectors obtained through PCA, and a vertical axis (y-axis) of the graph represents eigenvalues respectively corresponding to the eigenvectors.

For example, the principal component analyzer 131 may determine eigenvectors and eigenvalues corresponding thereto by performing eigenvalue decomposition on a covariance matrix of the merged reflected signal data. Each eigenvalue represents the magnitude of variance of the merged reflected signal data in a direction of a corresponding eigenvector. That is, this indicates that as an eigenvalue corresponding to a certain eigenvector increases, a variation in the merged reflected signal data in the direction increases.

In the graph of FIG. 8, each point on the x-axis represents an individual eigenvector and is numbered sequentially starting from 1. A value at each point on the y-axis represents an eigenvalue corresponding to an eigenvector of a corresponding number. As shown in the graph, some eigenvectors have relatively large eigenvalues, indicating that there is a major variation in the merged reflected signal data in the direction of the eigenvector.

The PCA results may be used to identify major variation components of the merged reflected signal data, and may then be utilized to detect the position of a defect within the test subject S.

Referring to FIG. 9, PCA results for a semiconductor substrate having a plurality of patterns are expressed as a two-dimensional image. This image visualizes results obtained through PCA of merged reflected signal data from the semiconductor substrate, which is the test subject S.

A plurality of patterns predetermined to simulate defects are formed on the semiconductor substrate. The patterns are intentionally formed and are provided to simulate a situation in which actual defects occur. In the image obtained through PCA, these patterns show a characteristic distribution that is distinguished from the periphery.

Differences in brightness within the image indicate the degree of variance in the merged reflected signal data. Areas that appear relatively bright indicate areas with high data variance, suggesting that the areas may be areas with characteristics that are different from a normal pattern, that is, potential defect areas.

The visualized PCA results may visually represent areas with high data variance. The defect sensor 132 may detect a defect by comparing the visualized results with mask data that forms a pattern of the test subject S. Areas that exhibit high variance that is different from the normal pattern may be determined as areas with a high probability of defect presence.

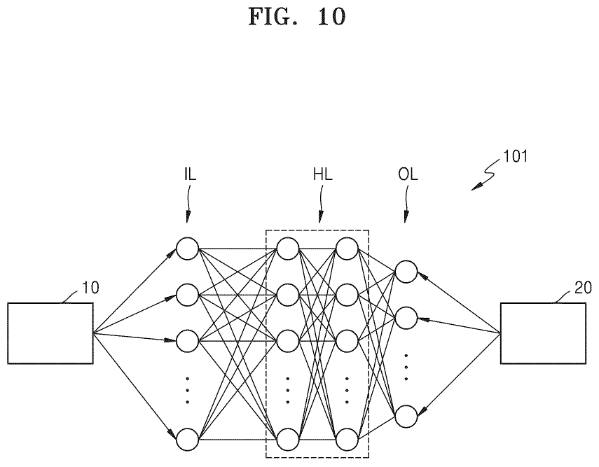

FIG. 10 is a schematic block diagram of a deep learning model 101.

Referring to FIG. 10, the deep learning model 101 may include an input layer IL that receives input data 10, at least one hidden layer HL, and an output layer OL that generates output data 20.

The input layer IL may receive, as input data 10, signal data representing a change in amplitude of an ultrasonic signal reflected from a test subject S. For example, the input data 10 may include amplitude values of a signal reflected from the surface of the test subject S and may include amplitude values of a signal reflected from a defect within the test subject S.

The hidden layer HL may extract features for identifying a defect from the input data 10. In some embodiments, the hidden layer HL may include a first hidden layer and a second hidden layer. The first hidden layer may learn low-level features of the input data 10, and the second hidden layer may learn combined features from the low-level features. Accordingly, the hidden layer HL may extract high-level features corresponding to a defect.

In some embodiments, parameters of the hidden layer HL may be optimized based on supervised learning. For example, training data indicating defective positions may be provided to the hidden layer HL, and the parameters of the hidden layer HL may be updated based on error back-propagation.

Based on the features extracted from the hidden layer HL, the output layer OL may generate output data 20 indicating the presence of a defect. For example, when features extracted from a defective area of the test subject S are different from features extracted from a normal area, the output data 20 may be determined to have a defect.

The defect detector 140 may detect a defect in the test subject S by using a training dataset generated by the training data generator 130. For example, the defect detector 140 may detect a defect using the deep learning model 101 and generate, based on training results of the deep learning model 101, a defect image that indicates a defect in the test subject S.

The defect detector 140 may train the deep learning model by using the training dataset. For example, merged reflected signal data included in the training dataset and defect presence information associated with the merged reflected signal data may be input to the deep learning model. The deep learning model may update weights based on the input training dataset and determine the presence of a defect in new merged reflected signal data by using the updated weights.

The defect detector 140 may identify a position where a defect is present in the test subject S by using training results of the deep learning model. For example, the defect detector 140 may identify a position where a defect is present by processing pieces of reflected signal data obtained at a plurality of positions of the test subject S in a vertical direction. Also, the defect detector 140 may generate a defect image that indicates a defect in an image of the test subject S by using position information about the identified defect.

The defect detector 140 may objectively and efficiently detect a defect in the test subject S having a complex structure, such as a layered semiconductor. Also, the defect detector 140 may identify various types of defect patterns through training of the deep learning model and visually present the position of a defect through the defect image.

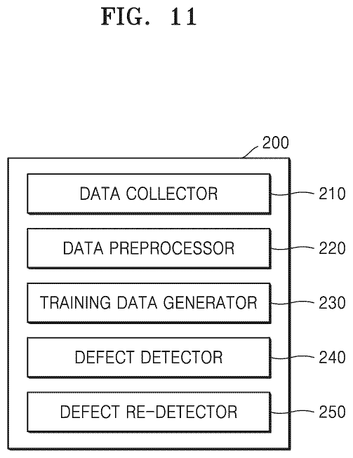

FIG. 11 is a schematic block diagram of a defect detection module 200 according to at least one embodiment.

Referring to FIG. 11, the defect detection module 200 according to at least one embodiment is different from the defect detection module 100 of FIG. 1 in that the defect detection module 200 further includes a defect re-detector 250. In detail, the defect detection module 200 shown in FIG. 11 includes a data collector 210, a data preprocessor 220, a training data generator 230, and a defect detector 240, and these components are respectively the same as and/or substantially similar to the data collector 110, the data preprocessor 120, the training data generator 130, and the defect detector 140 of the defect detection module 100 shown in FIG. 1.

The defect detector 240 may be configured to detect a defect in a test subject S by using a deep learning model and perform a retraining process on the deep learning model to improve the accuracy of detection results. When a defect detected by the deep learning model does not match a defect detected by the training data generator 230, the defect detector 240 may attempt to re-detect the defect, update detected defect information in a training dataset based on the results of the re-detect, and retrain the deep learning model to improve the accuracy of defect detection.

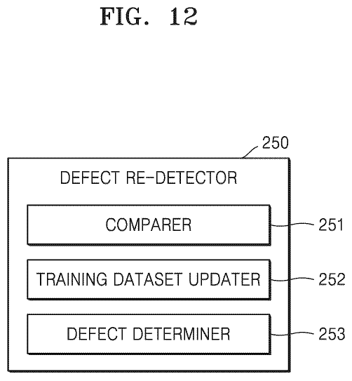

FIG. 12 is a schematic block diagram illustrating an example of the defect re-detector 250 of FIG. 11.

Referring to FIG. 12, an example of the defect re-detector 250 may include a comparer 251, a training dataset updater 242, and a defect determiner 253.

The comparer 251 may be configured to determine whether two results match by comparing a defect detected by a deep learning model with a defect detected through PCA by the training data generator 230.

The comparer 251 may comprehensively compare and analyze various characteristics of defects, such as position, size, and shape. For example, coordinates corresponding to the positions of defects that occur in a test subject S may be compared to determine whether the defects correspond to the same defect. Also, geometric characteristics of the defects, such as size and shape, may be compared to evaluate whether the characteristics of the defects match.

The comparer 251 may quantitatively analyze the difference between two results. For example, the distance between the position of the defect detected by the deep learning model and the position of the defect detected through PCA may be calculated. When this distance is less than a preset threshold value, the two defects may be determined to correspond to the same defect.

The comparer 251 may evaluate defect detection performance of the deep learning model based on comparison results. When the results of the deep learning model do not match the results of the PCA, it indicates that the deep learning model failed to accurately detect a corresponding type of defect. This mismatch information may be transmitted to the training dataset updater 242 and utilized to improve the performance of the deep learning model.

Comparison and analysis results from the comparer 251 may function as important feedback in a training process of the deep learning model. In order to improve the accuracy defect detection, the comparer 251 may continuously compare the two results and analyze the differences to support the deep learning model to accurately identify various defect patterns.

The training dataset updater 242 be configured to may perform a function of updating a training dataset based on the comparison results from the comparer 251. In detail, when the defect detected by the deep learning model does not match the defect detected through the PCA, defect detection results from the deep learning model are added as new training data.

The training dataset updater 242 may convert output data from the deep learning model into a form suitable for the training dataset and add the same. For example, information such as position, size, and characteristics of the defect detected by the deep learning model is converted to the format of an existing training dataset. In this case, integrating new data while maintaining the structure and consistency of existing training data is important.

The training dataset updater 242 may perform a process of verifying the reliability of data when adding new data. For example, the training dataset updater 242 may evaluate whether the defect detected by the deep learning model is likely to be an actual defect and add only data with high reliability to the training dataset. This verification process may play a key role in maintaining the quality of the training dataset.

The training dataset updater 242 may also perform a function of maintaining the balance of the updated training dataset. The training dataset updater 242 may manage the ratio of defective data and non-defective data to be maintained appropriately and may prevent a certain type of defective data from becoming excessively large. This allows the deep learning model to learn various defect patterns evenly without being biased.

The updated training dataset may be transmitted to the defect determiner 253 and used for retraining the deep learning model. Through this continuous dataset update and retraining process, the defect detection performance of the deep learning model may be progressively improved.

The defect determiner 253 may be configured to perform a function of inputting the updated training dataset to the deep learning model and finally determining whether a defect is present in data output by the deep learning model.

The defect determiner 253 may first process the updated training dataset received from the training dataset updater 242 according to an input format of the deep learning model. This may include a process of converting the data into an appropriate format such that the deep learning model may effectively learn the data. For example, a preprocessing operation such as resizing or normalizing the input data may be performed.

The defect determiner 253 may retrain the deep learning model by using the preprocessed training dataset. In a retraining process, weights of the deep learning model may be updated by using the entire dataset including newly added defect data. Through this retraining, the deep learning model may learn new defect patterns and have improved defect detection performance.

The defect determiner 253 may redetermine the presence of a defect in the test subject S by using the retrained deep learning model. In this case, the presence of a defect may be determined by analyzing results output from the deep learning model. For example, when an output value of the deep learning model exceeds a certain threshold value, a corresponding area may be determined as defective.

Determination results from the defect determiner 253 may be transmitted back to the comparer 251 to evaluate whether the determination results match PCA results. Through this cyclical process, the accuracy of defect detection by the deep learning model may be continuously improved. In particular, the detection performance for new types of defects or defects that were previously difficult to detect may be improved.

The operation of the defect determiner 253 may play a key role in enabling the deep learning model to detect defects more accurately in the test subject S having a complex structure, such as a stacked semiconductor.

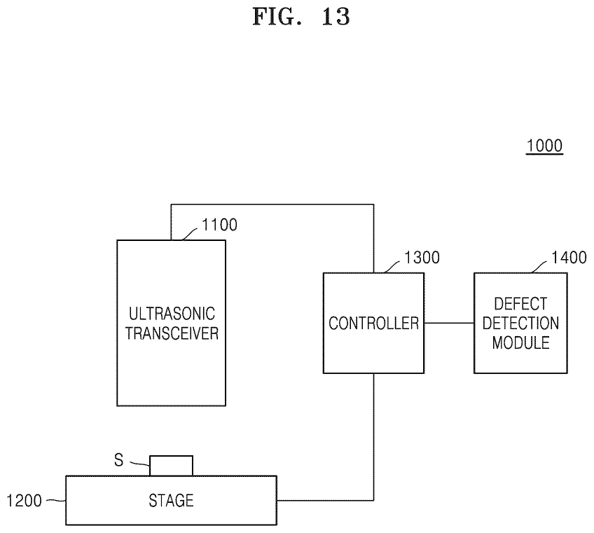

FIG. 13 is a schematic block diagram of a defect detection apparatus 1000 according to at least one example embodiment.

Referring to FIG. 13, the defect detection apparatus 1000 according to at least one example embodiment includes an ultrasonic transceiver 1100, a stage 1200, a controller 1300, and a defect detection module 1400.

The ultrasonic transceiver 1100 may transmit ultrasonic waves toward a test subject S and receive the ultrasonic waves reflected from the test subject S to generate reflected signal data.

The ultrasonic transceiver 1100 may include, for example, an ultrasonic transmitter (not shown) that is configured to transmit ultrasonic waves, and an ultrasonic receiver (not shown) that is configured to receive the ultrasonic waves reflected from the test subject S.

The ultrasonic transmitter may include a pulse generator configured to generate ultrasonic waves in an A-mode, and a piezoelectric element configured to transform pulses generated by the pulse generator into ultrasonic waves. The pulse generator may generate a pulse signal having a constant frequency. The piezoelectric element may generate ultrasonic waves by converting the pulse signal into mechanical vibrations.

The ultrasonic receiver may include a receiving piezoelectric element that receives ultrasonic waves reflected from the test subject S and converts the ultrasonic waves into an electrical signal, and a signal amplifier that amplifies the electrical signal. The receiving piezoelectric element may convert mechanical vibrations of the received ultrasonic waves into an electrical signal. The signal amplifier may generate reflected signal data by amplifying the electrical signal.

According to at least one example embodiment, the ultrasonic transmitter and the ultrasonic receiver may be implemented by a single piezoelectric element. In this case, the piezoelectric element may perform transmission and reception of ultrasonic waves in a time-division manner.

The ultrasonic transceiver 1100 may further include a movement mechanism (not shown) that is configured to change a relative position with respect to the test subject S. The movement mechanism may include, for example, a stepping motor and a motion conversion mechanism that converts a rotational motion of the stepping motor into a linear motion. The controller 1300 may control the movement mechanism to adjust the distance between the ultrasonic transceiver 1100 and the test subject S.

According to at least one example embodiment, the ultrasonic transceiver 1100 may further include an angle adjustment mechanism (not shown) configured to adjust transmission and reception angles of ultrasonic waves. The angle adjustment mechanism may include a rotation axis and a rotation motor that rotates the rotation axis. The controller 1300 may control the angle adjustment mechanism to adjust the transmission and reception angles of the ultrasonic waves.

According to at least one example embodiment, the stage 1200 may include a stage body on which the test subject S is placed, an X-axis movement unit that moves the stage body in an X-axis direction, a Y-axis movement unit that moves the stage body in a Y-axis direction, and a Z-axis movement unit that moves the stage body in a Z-axis direction.

The stage body may include a vacuum adsorption mechanism configured to fix the test subject S. The vacuum adsorption mechanism may include a vacuum pump, a vacuum line, and a plurality of vacuum holes formed in the upper surface of the stage body. The vacuum pump may be connected to the plurality of vacuum holes through the vacuum line. The controller 1300 may control the vacuum pump to fix the test subject S to the stage body.

The X-axis movement unit may include a first guide rail extending in the X-axis direction, a first slider that moves along the first guide rail, and a first driving motor that drives the first slider. The controller 1300 may control the first driving motor to move the stage body in the X-axis direction.

The Y-axis movement unit may include a second guide rail extending in the Y-axis direction, a second slider that moves along the second guide rail, and a second driving motor that drives the second slider. The controller 1300 may control the second driving motor to move the stage body in the Y-axis direction.

The Z-axis movement unit may include a third guide rail extending in the Z-axis direction, a third slider that moves along the third guide rail, and a third driving motor that drives the third slider. The controller 1300 may control the third driving motor to move the stage body in the Z-axis direction.

According to at least one example embodiment, the stage 1200 may further include a rotator that rotates the stage body. The rotator may include a rotation axis and a rotation motor that drives the rotation axis. The controller 1300 may control the rotation motor to rotate the stage body.

According to at least one example embodiment, the controller 1300 may include a processor (e.g., a central processing unit), a memory storing a program, a system bus that connects the central processing unit and the memory to each other, and an input/output interface (not shown) connected to the central processing unit and the memory through the system bus.

The central processing unit may be configured to control some or all of the operations of the ultrasonic transceiver 1100 and the stage 1200. The processor may control the operation of the ultrasonic transmitter and the ultrasonic receiver of the ultrasonic transceiver 1100 by sequentially executing instructions of the program. Also, the processor may control the operation of the X-axis movement unit, the Y-axis movement unit, the Z-axis movement unit, and the rotator of the stage 1200.

The memory may store data and programs executed by the processor. The memory may store an ultrasonic control program configured to control the operation of the ultrasonic transceiver 1100, a stage control program configured to control the operation of the stage 1200, and a defect detection program configured to control the operation of the defect detection module 1400.

The input/output interface may provide a communication interface for data transmission and reception with the ultrasonic transceiver 1100, the stage 1200, and the defect detection module 1400. The input/output interface may include a serial communication interface, such as a universal asynchronous receiver/transmitter (UART), a serial peripheral interface (SPI), and an inter-integrated circuit (I2C).

The controller 1300 may further include a user interface. The user interface may include a display apparatus such as a touchscreen, and an input apparatus such as a keyboard or a mouse. A user may control the operation of the defect detection apparatus 1000 and check results through the user interface.

The controller 1300 may further include an external storage apparatus. The external storage apparatus may include a large-capacity storage apparatus, such as a hard disk drive (HDD) or a solid-state drive (SSD). The external storage apparatus may store reflected signal data generated by the ultrasonic transceiver 1100, defect detection results generated by the defect detection module 1400, or the like.

The defect detection module 1400 may preprocess the reflected signal data and detect a defect in the test subject S by using a deep learning model. The defect detection module 1400 may be, for example, the defect detection module 100 of FIG. 1 and/or the defect detection module 200 of FIG. 11. Thus, description of the defect detection module 1400 is omitted. Though the example illustrated in FIG. 13 includes the defect detection module 1400 as separate from the controller 1300, the examples are not limited thereto. For example, in at least some examples, the defect detection module 1400 may be included in the controller 1300.

Additionally, in at least some examples, the controller 1300 may be configured to control the production of a stacked semiconductor package based on a result of the defect detection module 1400. For example, the controller 1300 may be configured to the result of the defect detection module 1400 may be enable (e.g., instruct and/or initiate) further processes based on the results. For example, in at least some examples, the controller 1300 may be configured to identify a type and/or magnitude of the defect from the results, and may initiate corrective processes to the stacked semiconductor package when the defect is correctable, and/or to discard the stacked semiconductor package. Additionally, when the controller 1300 confirms that there is not a defect, or the defect is within a manufacturing tolerance, the controller 1300 may initiate further processing to the stacked semiconductor package. In at least one example embodiment, the controller 1300 may hold the stacked semiconductor package for additional review, e.g., by a user.

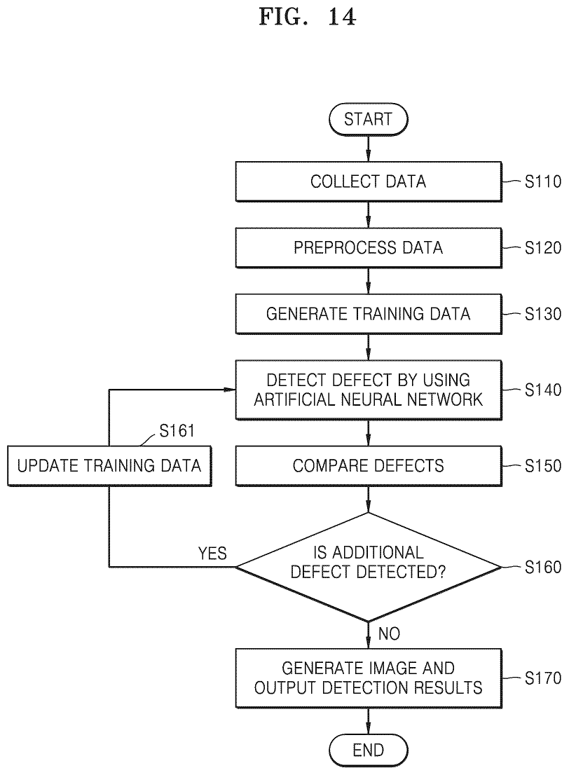

FIG. 14 is a schematic flowchart illustrating a defect detection method according to at least one example embodiment.

Referring to FIG. 14, the defect detection method according to at least one example embodiment includes a data collection operation S110, a data preprocessing operation S120, a training data generation operation S130, a defect detection operation S140, a defect comparison operation S150, an additional defect identification operation S160, and a defect image generation operation S170.

The data collection operation S110 may include an operation of obtaining an ultrasonic signal for a test subject S and an operation of generating reflected signal data by processing the obtained ultrasonic signal.

In the operation of obtaining the ultrasonic signal, ultrasonic waves in an A-mode may be transmitted toward the test subject S by using an ultrasonic transmitter, and the ultrasonic waves reflected from the test subject S may be received by using an ultrasonic receiver. In at least some examples, the transmission and reception of the ultrasonic waves may be repeated a plurality of times.

In the operation of generating the reflected signal data, reflected ultrasonic waves received from the ultrasonic receiver may be converted into an electrical signal, and the converted electrical signal may be amplified and then converted into a digital signal to generate the reflected signal data. The generated reflected signal data may include an amplitude value of the reflected ultrasonic waves over time.

According to at least one example embodiment, the transmission and reception of the ultrasonic waves may be performed by changing the distance between the ultrasonic transceiver and the test subject S. In this case, the distance between the ultrasonic transceiver and the test subject S may be adjusted by a movement mechanism. This allows detection of defects present at various depths in the test subject S.

Also, the transmission and reception of the ultrasonic waves may be performed by changing an incident angle of the ultrasonic waves. In this case, the incident angle of the ultrasonic waves may be adjusted by an angle adjustment mechanism. This allows detection of defects present in the test subject S in various directions.

The reflected signal data obtained through the data collection operation S110 may be processed in the subsequent data preprocessing operation S120 and used to generate merged reflected signal data.

The data preprocessing operation S120 may include an extraction operation of extracting reflected signal data, a number assignment operation of assigning a number to extracted data, a normalization operation of normalizing the extracted data, and a merging operation of merging the normalized data.

In the extraction operation, a portion of the reflected signal data obtained in the data collection operation S110 may be extracted. In this case, the extracted portion of the reflected signal data may be data corresponding to a depth range where a defect is expected to be present in the test subject S. For example, the reflected signal data may be extracted from the surface of the test subject S to a certain depth.

In the number assignment operation, a unique identification number may be assigned to the extracted reflected signal data. The identification number may include information about a position where data was obtained, information about the distance between the ultrasonic transceiver and the test subject S, and information about an incident angle of ultrasonic waves. Accordingly, extracted data may be systematically managed.

In the normalization operation, the amplitude of the extracted reflected signal data may be normalized. Normalization may be performed to transform pieces of data obtained under different conditions into the same scale. For example, the maximum amplitude value of each piece of data may be normalized to 1, and the minimum amplitude value thereof may be normalized to 0.

In the merging operation, pieces of normalized reflected signal data may be merged into one piece of data to generate merged reflected signal data. When merging, pieces of data may be sorted based on identification numbers of respective pieces of data. The merged data may be used as input data for PCA in the subsequent training data generation operation S130.

The merged reflected signal data generated through the data preprocessing operation S120 may have improved data consistency and reliability, which may contribute to improving the accuracy of defect detection.

The training data generation operation S130 may include a defect position detection operation of detecting the position of a defect by performing PCA on the merged reflected signal data, and a data classification operation of generating a training dataset by classifying the merged reflected signal data according to the inclusion of a defect.

In the defect position detection operation, PCA may be performed on the merged reflected signal data. PCA is a statistical technique that reduces the dimension of high-dimensional data and extracts major features of the data. The PCA may be used to identify a direction in which the variance of the merged reflected signal data is maximized, and this may provide information related to the position of a defect within the test subject S.

In the data classification operation, the merged reflected signal data may be classified into defect-including data and defect-free data based on PCA results. In this case, classification criteria may be set based on the statistical distribution of feature values obtained through the PCA. For example, when a feature value exceeds a certain threshold value, corresponding data may be classified as defect-including data.

Pieces of classified data may be used to form a training dataset. The training dataset may be configured to include defect-including data and defect-free data in an appropriate ratio. This is to protect against data imbalance problems that may occur during a training process of a deep learning model.

The training dataset generated through the training data generation operation S130 may be used as input data for training the deep learning model and for defect detection in the subsequent defect detection operation S140. Also, in the subsequent defect comparison operation S150, the training dataset may be utilized as reference data to verify the accuracy of defect detection results.

The defect detection operation S140 is an operation of detecting a defect in the test subject S by using the deep learning model and may include a deep learning model training operation and a defect detection performance operation.

In the deep learning model training operation, the deep learning model may be trained by using the training dataset generated through the training data generation operation S130. The deep learning model may be implemented based on a convolutional neural network (CNN) and may include an input layer, a plurality of convolutional layers and pooling layers, a fully-connected layer, and an output layer. In each convolutional layer, a filter for extracting features of input data may be learned, and in the pooling layers, the dimension of the extracted features may be reduced.

In the defect detection performance operation, defect detection may be performed on new reflected signal data by using the trained deep learning model. In this case, the new reflected signal data may be data processed through the data collection operation S110 and the data preprocessing operation S120. The deep learning model may determine the presence of a defect in input data, and when a defect is present, may output information about the position and size of the defect.

In order to increase the accuracy of defect detection, the deep learning model may be trained using cross-validation. Also, regularization techniques such as dropout and batch normalization may be applied to prevent overfitting.

In the subsequent defect comparison operation S150, results of the defect detection operation S140 may be compared with the defect detected in the training data generation operation S130, thereby verifying the reliability of detection results.

The defect comparison operation S150 may include determining whether the defect detected by the deep learning model in the defect detection operation S140 matches the defect detected through PCA in the training data generation operation S130.

The defect comparison operation S150 may include first extracting characteristic data of the defect detected by the deep learning model. The characteristic data may include a coordinate value representing the position of the defect, an area value representing the size of the defect, and a geometric feature value representing the shape of the defect.

The defect comparison operation S150 may also include extracting characteristic data of the defect detected through PCA in the same manner. Pieces of the extracted characteristic data may be converted into a standardized format for quantitative comparison and analysis. The position may be converted into units of pixels, the area may be converted into units of square pixels, and shape features may be converted into normalized numerical values.

According to at least one example embodiment, the pieces of the standardized characteristic data may be compared within a preset tolerance range. The tolerance range may be set to, for example, a position error of ±5 pixels, an area error of ±10%, and a shape similarity of 0.9 or higher. When all characteristics fall within the tolerance range, the two defects may be determined to match.

The defect comparison operation S150 may include determining a subsequent processing process based on comparison results. When the defects match, the additional defect identification operation S160 may be performed, and when the defects do not match, a training dataset update operation S161 may be performed.

The defect comparison operation S150 may include storing the comparison results in a database. The database may store not only the comparison results, but also error information when a mismatch occurred. Stored information may be utilized to evaluate and enhance system performance.

The additional defect identification operation S160 may include, when the defect detected in the defect detection operation S140 matches the defect detected in the training data generation operation S130, generating and outputting a defect including the defect.

The training dataset update operation S161 may include, when the defect detected in the defect detection operation S140 does not match the defect detected in the training data generation operation S130, updating the training dataset with the defect detected in the defect detection operation.

The updated training dataset may be used to retrain the deep learning model. For example, new defect data may be added to an existing training dataset to generate an extended training dataset, and weights of the deep learning model may be updated by using the extended training dataset.

The defect image generation operation S170 may include generating and outputting a defect image including the defect.

While the inventive concepts have been described with reference to the embodiments illustrated in the drawings, these embodiments are merely exemplary, and those of ordinary skill in the art will understand that various modifications and other equivalent embodiments may be made therefrom. Accordingly, the true technical scope of protection of the inventive concepts should be determined by the technical spirit of the appended claims.

While the inventive concepts have been particularly shown and described with reference to embodiments thereof, it will be understood that various changes in form and details may be made therein without departing from the spirit and scope of the following claims.

What is claimed is:

1. A defect detection module comprising:
processing circuitry configured to
collect reflected signal data of an amplitude-mode ultrasonic wave for a test subject;
generate merged reflected signal data by extracting a portion of the collected reflected signal data, assigning numbers to the extracted portion of the collected reflected signal data, normalizing amplitudes of the extracted portion of the collected reflected signal data, and then merging the extracted portion of the collected reflected signal data;
generate a training dataset by detecting a position of a defect within the test subject using a principal component analysis on the merged reflected signal data, and classifying the merged reflected signal data into defect-including data and defect-free data; and
detect the defect in the test subject using the training dataset and a deep learning model,
wherein the collected reflected signal data is collected as a position of the amplitude-mode ultrasonic wave is changed relative to the test subject.

2. The defect detection module of claim 1, wherein the deep learning model is trained based on the test subject including a stacked semiconductor.

3. The defect detection module of claim 1, wherein, in the generate the merged reflected signal data, the processing circuitry is configured to
extract, from the collected reflected signal data, reflected signal data in which an absolute value of an amplitude of the reflected signal data is at or greater than a threshold value;
assign numbers to respective pieces of the extracted reflected signal data;
normalize amplitudes of the pieces of the extracted reflected signal data; and
generate the merged reflected signal data by collecting the normalized amplitudes of the pieces of the extracted reflected signal data in order of the assigned numbers.

4. The defect detection module of claim 3, wherein in the generate the training dataset, the processing circuitry is configured to:
determine an eigenvalue corresponding to an eigenvector by performing eigenvalue decomposition on a covariance matrix of the merged reflected signal data, wherein the eigenvalue represents a variance of the merged reflected signal data in a direction of the eigenvector;
detect the defect within the test subject by comparing the variance with mask data forming a pattern of the test subject;
classify the merged reflected signal data into the defect-including data and the defect-free data; and
form the merged reflected signal data into the training dataset,
wherein the merged reflected signal data is classified based on a presence of the defect, and
wherein the variance represents a variation in the merged reflected signal data.

5. The defect detection module of claim 4, wherein the processing circuitry includes a principle component analyzer configured to determine the eigenvalue, and
the comparing the variance and the mask data includes at least one of converting data formed by the principal component analyzer into a format of the mask data or converting the format of the mask data into a format of the data formed by the principal component analyzer.

6. The defect detection module of claim 1, wherein the deep learning model includes at least one of a multi-layer perceptron, a convolutional neural network, or a recurrent neural network.

7. The defect detection module of claim 1, wherein the processing circuitry is further configured to generate a defect image in which a defect detected by training of the deep learning model is displayed.

8. The defect detection module of claim 1, wherein the processing circuitry is further configured to re-detect the defect when the defect detected using the deep learning model is different from the defect detected using the principal component analysis, by
updating the training dataset based on data output by a training of the deep learning model, and
inputting the updated training dataset to the deep learning model.

9. The defect detection module of claim 8, wherein, in the re-detect the defect, the processing circuitry is configured to
determine whether the defect detected using the principal component analysis matches the defect detected using the deep learning model;
update the training dataset with the defect detected using the deep learning model when the defect detected by the deep learning model does not match the defect detected using the principal component analysis;
input the updated training dataset to the deep learning model; and
re-determine whether data output from the deep learning model includes the defect.

10. A defect detection apparatus comprising:
a stage configured to receive a test subject;
an ultrasonic transceiver configured to generate reflected signal data by transmitting an ultrasonic wave toward the test subject, and receiving the ultrasonic wave reflected from the test subject;
a controller configured to control the stage and the ultrasonic transceiver; and
a defect detection module configured to preprocess the reflected signal data, and to detect a defect in the test subject using a deep learning model and the preprocessed reflected signal data,
wherein the ultrasonic wave is an amplitude-mode ultrasonic wave, and
the reflected signal data is formed by changing a distance between the ultrasonic transceiver and the test subject.

11. The defect detection apparatus of claim 10, wherein the defect detection module comprises processing circuitry configured to
collect the reflected signal data;
generate merged reflected signal data by extracting a portion of the collected reflected signal data, assigning numbers to the extracted portion of the collected reflected signal data, normalizing amplitudes of the extracted portion of the collected reflected signal data, and then merging the extracted portion of the collected reflected signal data;
generate a training dataset by detecting a position of a defect within the test subject using principal component analysis on the merged reflected signal data, and classifying the merged reflected signal data into defect-including data and defect-free data; and
detect the defect in the test subject using the training dataset and the deep learning model.

12. The defect detection apparatus of claim 11, wherein, in the generate the training dataset, the processing circuitry is configured to
determine an eigenvalue corresponding to an eigenvector by performing eigenvalue decomposition on a covariance matrix of the merged reflected signal data, wherein the eigenvalue represents a variance of the merged reflected signal data in a direction of the eigenvector;
detect the defect within the test subject by comparing the variance with mask data forming a pattern of the test subject;
classify the merged reflected signal data into the defect-including data and the defect-free data; and
form the merged reflected signal data into the training dataset, the merged reflected signal data being classified based on a presence of the defect,
wherein the variance represents a major variation in the merged reflected signal data.

13. The defect detection apparatus of claim 12, wherein the processing circuitry includes a principle component analyzer configured to determine the eigenvalue, and
in the comparing the variance and the mask data, includes at least one of converting data formed by the principal component analyzer into a format of the mask data or converting the format of the mask data into a format of the data formed by the principal component analyzer.

14. The defect detection apparatus of claim 10, wherein the deep learning model is at least one of a multi-layer perceptron, a convolutional neural network, or a recurrent neural network.

15. The defect detection apparatus of claim 10, wherein the defect detection module is further configured to generate a defect image in which a defect detected by training of the deep learning model is displayed.

16. The defect detection apparatus of claim 11, wherein the defect detection module is further configured to re-detect the defect when the defect detected using the deep learning model is different from the defect detected using the principal component analysis, by
updating the training dataset with output data output by a training of the deep learning model, and
inputting the updated training dataset to the deep learning model.

17. The defect detection apparatus of claim 16, wherein, in the re-detect the defect the processing circuitry is configured to:
determine whether the defect detected using the principal component analysis matches the defect detected using the deep learning model;
update the training dataset with the defect when the defect detected using the principal component analysis does not match the defect detected using the principal component analysis;
input the updated training dataset to the deep learning model; and
re-determine whether data output from the deep learning model includes the defect.

18. A defect detection method comprising:
collecting reflected signal data from an amplitude-mode ultrasonic wave applied to a test subject;
extracting a portion of the collected reflected signal data;
assigning numbers to the extracted portion of the collected reflected signal data;
normalizing amplitudes of the extracted portion of the collected reflected signal data;
merging the normalized portion of the collected reflected signal data;
generating a training dataset by detecting a position of a defect within the test subject by performing principal component analysis on the merged reflected signal data and classifying the merged reflected signal data into defect-including data and defect-free data;
detecting the defect in the test subject using the training dataset and a deep learning model based on the training dataset;
comparing the defect detected in the defect detection step with the defect detected in the training data generating step; and
generating and outputting a defect image including the defect when the defect detected in the defect detection step matches the defect detected in the training data generating step.

19. The defect detection method of claim 18, wherein the generating the training dataset comprises:
performing principal component analysis on the merged reflected signal data;
detecting a defect within the test subject by comparing a variance of the merged reflected signal data obtained from the principal component analysis with mask data forming a pattern of the test subject;
classifying the merged reflected signal data into the defect-including data and the defect-free data; and
forming the training dataset from the merged reflected signal data that has been classified according to a presence of the defect.

20. The defect detection method of claim 18, further comprising, when the defect detected using the deep learning model does not match the defect detected using the principal component analysis:
updating the training dataset with the defect detected;
inputting the updated training dataset to the deep learning model and determining whether data output from the deep learning model includes the defect; and
generating and outputting a second defect image that includes the defect.
